(19) United States
(12) Patent Application Publication
(10) Pub. No.: US 2026/0100976 A1
(43) Pub. Date: Apr. 9, 2026

(54) PRINTER, PROGRAM, AND INFORMATION PROCESSING SYSTEM

(71) Applicant: SATO HOLDINGS KABUSHIKI KAISHA, Tokyo (JP)

(72) Inventor: Koichi SAITO, Tokyo (JP)

(73) Assignee: SATO HOLDINGS KABUSHIKI KAISHA, Tokyo (JP)

(21) Appl. No.: 19/112,505

(22) PCT Filed: Oct. 27, 2023
(86) PCT No.: PCT/JP2023/038851

§ 371 Date: Mar. 17, 2025

(30) Foreign Application Priority Data
Nov. 21, 2022 (JP) 2022-185417

(51) Int. Cl. H04L 65/1043; H04L 9/40

(52) U.S. Cl. CPC H04L 65/1043; H04L 63/20

(57) ABSTRACT

One aspect of the present invention is a printer comprising: a communication unit that communicates with a first device via a first gateway and communicates with a second device via a second gateway, the first gateway being connected to a local area network (LAN) and set as a default gateway, the second gateway being connected to a mobile communication network; and a control unit that, when communication malfunction occurs in communication with the first device during the communication with the first device via the first gateway, switches a gateway set as the default gateway from the first gateway to the second gateway and thereby controls the communication unit so as to communicate with the second device.

### FIELD

The present invention relates to a printer, a program, and an information processing system.

### BACKGROUND

A known technique includes detecting a failure in a line or device on a network and switching a communication route (Japanese Patent Application Laid-Open Publication No. 2009-182526).

### BRIEF SUMMARY

### Technical Problem

Incidentally, there is a case where when a printer is communicating with, for example, a computer terminal via a local area network (LAN), a network failure occurs due to detachment of a LAN cable or malfunction of a router, resulting in a communication error such as interruption of the communication with the computer terminal. In this case, a problem arises in that the printer cannot communicate with a device (e.g., a server that manages the printer) connected to an external network outside the network to which the printer belongs.

In view of the above, an object of the present invention is to, when an error occurs in communication of a printer with a certain device via a LAN, enable the printer to communicate with another device connected to an external network.

### Solution to Problem

An aspect of the present invention provides a printer including a communication unit and a control unit. The communication unit communicates with a first device via a first gateway connected to a LAN, and communicates with a second device via a second gateway connected to a mobile communication network. When communication with the first device is interrupted during the communication with the first device via the first gateway, the control unit switches a gateway set as a default gateway from the first gateway to the second gateway and thereby controls the communication unit so as to communicate with the second device.

### Advantageous Effects

According to an aspect of the present invention, when communication malfunction occurs in communication of a printer with a certain device via a LAN, the printer can communicate with another device connected to an external network.

### BRIEF DESCRIPTION OF DRAWINGS

FIG. 1 illustrates one example of a configuration of a communication system according to one embodiment.

FIG. 2 illustrates a connection relation between a printer and the Internet in the communication system according to one embodiment.

FIG. 3 illustrates image display examples in the printer according to one embodiment.

FIG. 4 illustrates a state where LAN communication by the printer is interrupted in the communication system illustrated in FIG. 2.

FIG. 5 illustrates a state after a default gateway of the printer is switched in the communication system illustrated in FIG. 2.

FIG. 6 is a flowchart representing processing in the printer according to one embodiment when LAN communication is interrupted.

FIG. 7 illustrates an example of a display change of an image on the printer according to one embodiment when LAN communication is interrupted.

FIG. 8 illustrates a state where communication by the printer via a SIM is interrupted in the communication system illustrated in FIG. 2.

FIG. 9 illustrates an example of a display change of an image on the printer according to one embodiment when communication via the SIM is interrupted.

FIG. 10 is a sequence chart in a case of acquiring packet data in the LAN when LAN communication is interrupted in the communication system according to one embodiment.

FIG. 11 illustrates one example of an image on an administrator terminal in the communication system according to one embodiment.

FIG. 12 illustrates one example of a packet analysis result in the communication system according to one embodiment.

### DETAILED DESCRIPTION

The following describes one embodiment of a printer, a program, and an information processing system according to the present invention. The below-described configurations are not limited to those in the drawings described in the brief description of the drawings.

A first aspect of the present invention is a printer that includes a communication unit and a control unit. The communication unit communicates with a first device via a first gateway that is connected to a local area network (LAN) and that is set as a default gateway. The communication unit communicates with a second device via a second gateway connected to a mobile communication network. When communication malfunction occurs in communication of the communication unit with the first device while the communication unit is communicating with the first device via the first gateway, the control unit switches a gateway set as the default gateway from the first gateway to the second gateway and thereby controls the communication unit so as to communicate with the second device.

In the present disclosure, “local area network (LAN)” may be a network having any size as long as the network is a network (sub-network) uniquely identified by a network address. The LAN may be a wired network or a wireless network. In the case of the wireless network, the network is based on a standard such as IEEE802a/b/g/j/n/ac/ad.

In the present disclosure, “gateway” is a physical network node that relays data transmitted and received between different networks, in a computer network. Examples of the gateway include a router, a switch, a switching hub, and the like. The router is a device that relays data between the different networks. The switch or the switching hub is a device that utilizes switching to connect devices to each other on the computer network so as to receive data and transfer the data to a destination device.

In the present disclosure, “mobile communication network” is not limited to one implementing particular specifications, and is not particularly limited as long as the mobile communication network is a wireless communication system that is being operated or planned to be operated by a mobile communication carrier. Examples cited as such a wireless communication system include a wireless communication system based on the IMT-Advanced standard and generally called 4G, a wireless communication system based on the IMT-2020 standard and generally called 5G, and any wireless communication system after 5G.

In the present disclosure, “first device” may be any device that is connected to the LAN. Examples cited as the first device include a computer device, a smartphone, and a tablet terminal.

In the present disclosure, “second device” may be any device that is connected to the mobile communication network. For example, the second device is a device that can access the mobile communication network and whose examples include a computer device and a server.

According to the first aspect of the present invention, when communication malfunction occurs in communication of the printer with the first device via the LAN, the printer can communicate with the second device connected to an external network.

A second aspect of the present invention is the printer according to the first aspect, in which when the communication of the communication unit with the first device is restored, the control unit controls the communication unit by switching a gateway set as the default gateway from the second gateway to the first gateway.

According to the second aspect of the present invention, when the communication between the communication unit and the first device is restored, a setting of the default gateway can be automatically returned to the original setting without requiring operation by a user.

A third aspect of the present invention is the printer according to the first or second aspect, in which the printer further includes a LAN analysis unit that analyzes a packet received via the LAN.

According to the third aspect of the present invention, a cause of communication malfunction occurring in the communication via the LAN can be analyzed.

A fourth aspect of the present invention is the printer according to the third aspect, in which the LAN analysis unit analyzes the packet in response to a request transmitted from the second device and received via the mobile communication network.

According to the fourth aspect of the present invention, execution of the packet analysis can be triggered via the second device even while the communication with the first device via the LAN is being interrupted.

A fifth aspect of the present invention is the printer according to any one of the first to fourth aspects, in which when communication malfunction occurs in the communication with the first device, the control unit controls the communication unit by restricting a communication port allowed in communicating with the second device via the second gateway.

According to the fifth aspect of the present invention, security at the time of the communication via the second gateway can be improved.

A sixth aspect of the present invention is the printer according to any one of the first to fifth aspects, in which when communication malfunction occurs in the communication with the first device, the control unit controls the communication unit so as to switch a domain name system (DNS) server to access for resolving a domain name, from a first DNS server connected to the LAN to a second DNS server connected to the mobile communication network.

According to the sixth aspect of the present invention, after a gateway set as the default gateway is switched from the first gateway to the second gateway, a domain name is resolved to enable Internet protocol (IP) communication.

A seventh aspect of the present invention is a program for controlling communication of a printer. The program causes a computer to function as: communication means and control means. The communication means communicate with a first device via a first gateway that is connected to a LAN and that is set as a default gateway. The communication means communicate with a second device via a second gateway connected to a mobile communication network. When communication malfunction occurs in communication of the communication means with the first device while the communication means are communicating with the first device via the first gateway, the control means switch a gateway set as the default gateway from the first gateway to the second gateway and thereby control the communication means so as to communicate with the second device.

According to the seventh aspect of the present invention, when communication malfunction occurs in communication of the printer with the first device via the LAN, the printer can communicate with the second device connected to an external network.

An eighth aspect of the present invention is an information processing system including a printer, and a server communicable with the printer. The printer includes a communication unit and a control unit. The communication unit communicates with an information processing device via a first gateway that is connected to a LAN and that is set as a default gateway. The communication unit communicates with the server via a second gateway connected to a mobile communication network. When communication malfunction occurs in communication of the communication unit with the information processing device while the communication unit is communicating with the information processing device via the first gateway, the control unit switches a gateway set as the default gateway from the first gateway to the second gateway and thereby controls the communication unit so as to communicate with the server. The LAN analysis unit analyzes a packet received via the LAN. The server includes an analysis request unit and an acquisition unit. The analysis request unit requests the printer to analyze a packet by the LAN analysis unit. The acquisition unit acquires, from the printer, a result of the analysis made by the LAN analysis unit.

According to the eighth aspect of the present invention, when communication malfunction occurs in communication of the printer with the information processing device via the LAN, the printer can communicate with the server connected to an external network, and the analysis result of the packet received by the printer via the LAN can be acquired.

A ninth aspect of the present invention is a control method for a printer. The method includes a step of communicating with a first device via a first gateway that is connected to a LAN and that is set as a default gateway, and communicating with a second device via a second gateway connected to a mobile communication network. The method includes a step of, when communication malfunction occurs in communication with the first device while communicating with the first device via the first gateway, switching a gateway set as the default gateway from the first gateway to the second gateway and thereby controlling communication so as to be made with the second device.

According to the ninth aspect of the present invention, when communication malfunction occurs in communication of the printer with the first device via the LAN, the printer can communicate with the second device connected to an external network.

A tenth aspect of the present invention is the printer according to any one of the first to sixth aspects, in which the printer selectively displays, on a display unit, a communication setting for communication via the first gateway or a communication setting for communication via the second gateway, in response to operation made by a user.

According to the tenth aspect of the present invention, the user can check the communication setting of the printer at an arbitrary timing.

The following describes an embodiment with reference to the drawings.

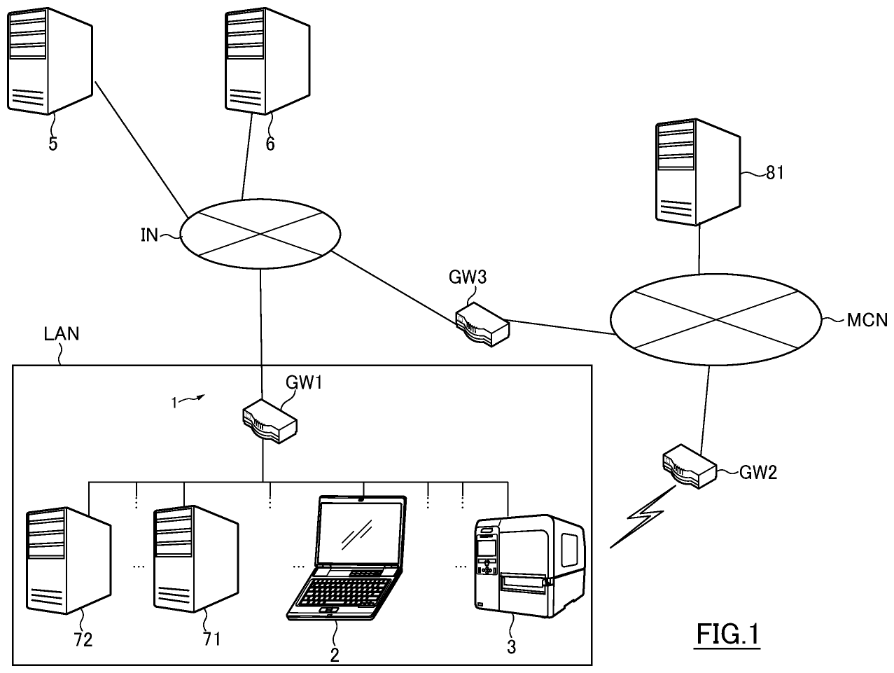

FIG. 1 illustrates a schematic configuration of a communication system 1 (one example of an information processing system) according to one embodiment.

A LAN in the communication system 1 is a network to which a gateway GW1 (one example of a first gateway), a user terminal 2, a printer 3, a DNS server 71, a DHCP server 72, and the like are connected. A proxy server and the like can also be connected to the LAN. The gateway GW1 is constituted by a router, for example. The router has a function of routing packets transmitted via the LAN. The gateway GW1 relays data transmitted and received between the devices connected to the LAN.

The printer 3 may be a stationary printer or a portable printer. The printer 3 receives a print request from the user terminal 2 connected to the LAN, and issues a printed medium such as a label, based on the received print request. The printer 3 is a thermal printer for example, but is not limited to this.

The user terminal 2 (one example of a first device) is, for example, an information processing device such as a computer device, a tablet terminal, or a smartphone. Examples of LAN communication made between the user terminal 2 and the printer 3 include a case where the user terminal 2 transmits a print request to the printer 3 and a case where the printer 3 transmits status information to the user terminal 2.

The gateway GW1 also involves a function of relaying, to a different network, packets transmitted via the LAN. The different network is a network (e.g., the Internet IN) outside the LAN.

The DNS server 71 (one example of a first DNS server) is a server that resolves a domain name. When a device in the LAN communicates with an external device connected to the Internet IN by specifying a domain name such as a URL, the device transmits a query to the DNS server 71 and thus acquires the destination IP address. When a device in the LAN communicates with an external device connected to the Internet IN, the dynamic host configuration protocol (DHCP) server 72 provides a service of assigning (lending) information such as an IP address to the device for a given period of time.

A management server 5 and an administrator terminal 6 are connected to the Internet IN.

The management server 5 (one example of a second device) is a server that manages an operating state of the printer 3. In the example illustrated in FIG. 1, only one printer 3 is depicted as being connected to the LAN. However, a printer to be managed by the management server 5 is not limited to this printer 3. The management server 5 can manage each of two or more printers connected to the LAN, or each of a large number of printers connected to a plurality of LANs.

The printer 3 and the management server 5 communicate with each other via the Internet IN. A communication protocol between the printer 3 and the management server 5 is not particularly limited, and may be the message queueing telemetry transport (MQTT) or the MQTT over WebSocket, for example. The MQTT is a lightweight publisher-subscriber type data communication protocol.

In order to receive a predetermined service from the management server 5, the printer 3 periodically transmits, to the management server 5, state information indicating a state of the printer 3 and setting information indicating a setting of the printer 3.

The management server 5 records, in a database, the state information and the setting information for each of the printers. Examples of the state information of the printer include, but are not limited to, a total transport distance of a platen roller, an operation time length of the printer, the number of issued labels, and error information. Examples of the setting information of the printer include, but are not limited to, a transport speed of the platen roller, a printing density, a type of a sensor installed in the printer, and information concerning a communication setting. Examples of the service provided by the management server 5 include, but are not limited to, the following:
notifying the user terminal 2 of the operating state and a load state of the printer 3;
notifying the user terminal 2 of a replacement timing for a consumable component of the printer 3; and
notifying the user terminal 2 of an error that has occurred in the printer 3.

The administrator terminal 6 is, for example, an information processing terminal such as a computer device, a tablet terminal, or a smartphone, and is a terminal operated by an administrator of the printer 3. A printer management application is installed in the administrator terminal 6. The printer management application communicates with the management server 5 via the Internet IN, and causes the state information and the setting information of the printer 3, recorded in the database of the management server 5, to be displayed. Thereby, the administrator can view the information of the printer 3.

The printer 3 is configured such that a subscriber identity module (SIM) card can be installed in the printer 3 in order to use a mobile communication service provided by a telecommunication carrier. The SIM card installed in the printer 3 enables the mobile communication network MCN to be used via a gateway GW2 (one example of a second gateway). The SIM card is one example of a user identification module that stores user identification information for managing use of the mobile communication network MCN for each user. Other examples cited as the user identification module include a universal subscriber identity module (UIM) card.

A DNS server 81 (one example of a second DNS server) is connected to the mobile communication network MCN. A gateway GW3 connected to the mobile communication network MCN relays data between the mobile communication network MCN and the Internet IN. The mobile communication network MCN and the gateway GW3 are provided by the telecommunication carrier. Thus, when the printer 3 communicates with the management server 5 or the administrator terminal 6, the printer 3 can transmit and receive data (packets) via the SIM card and the gateway GW2, instead of via the gateway GW1.

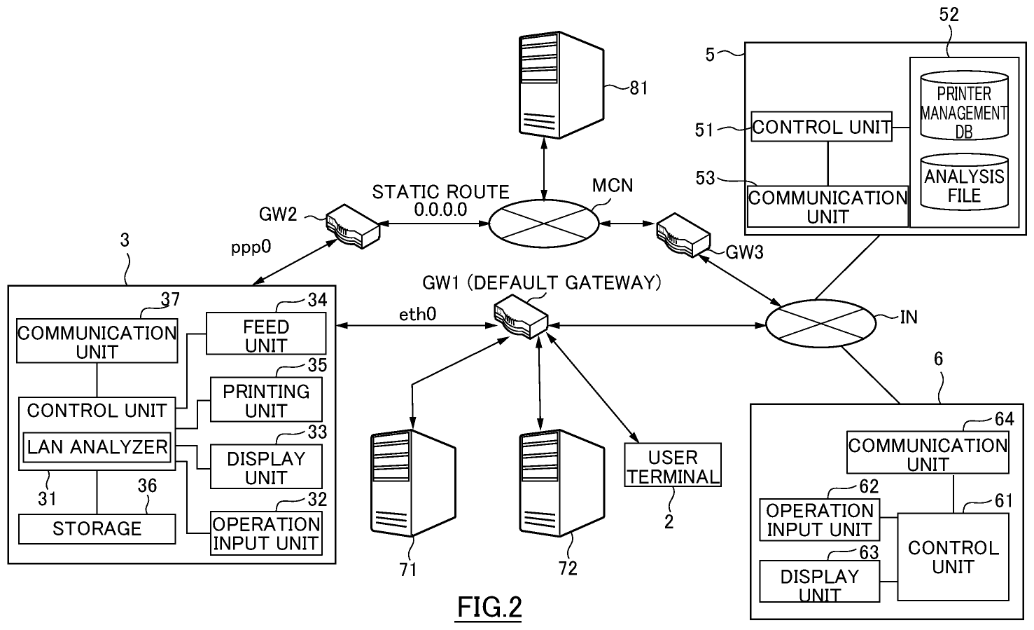

FIG. 2 illustrates communication paths from the printer 3 to the Internet IN in the communication system 1 illustrated in FIG. 1. FIG. 2 also illustrates a configuration included in each of the devices that are the printer 3, the management server 5, and the administrator terminal 6.

As illustrated in FIG. 2, in order for the printer 3 to communicate with the management server 5 or the administrator terminal 6, the printer 3 establishes connection to the Internet IN via the gateway GW1 connected to the LAN, or establishes connection to the Internet IN from the unillustrated SIM card via the gateway GW2, the mobile communication network MCN, and the gateway GW3.

As illustrated in FIG. 2, a gateway set as the default gateway of the printer 3 in an initial state is the gateway GW1. Accordingly, data to be transmitted from the printer 3 to the management server 5 outside the LAN are sent to the gateway GW1, and the domain name is resolved by the DNS server 71. Then, the data are transmitted to the management server 5 via the Internet IN.

Next, the configurations of the printer 3, the management server 5, and the administrator terminal 6 included in the communication system 1 illustrated in FIG. 1 are described with reference to FIG. 2.

The printer 3 includes a control unit 31, an operation input unit 32, a display unit 33, a feed unit 34, a printing unit 35, a storage 36, and a communication unit 37 as illustrated in FIG. 2.

The control unit 31 is constituted mainly by a microprocessor and a memory, and controls the entire printer 3. For example, the microprocessor included in the control unit 31 loads and executes firmware recorded in the storage 36. Thereby, the microprocessor controls the printing unit 35 so as to print information on a print medium such as a label, based on a print request transmitted from the user terminal 2 and acquired via the LAN.

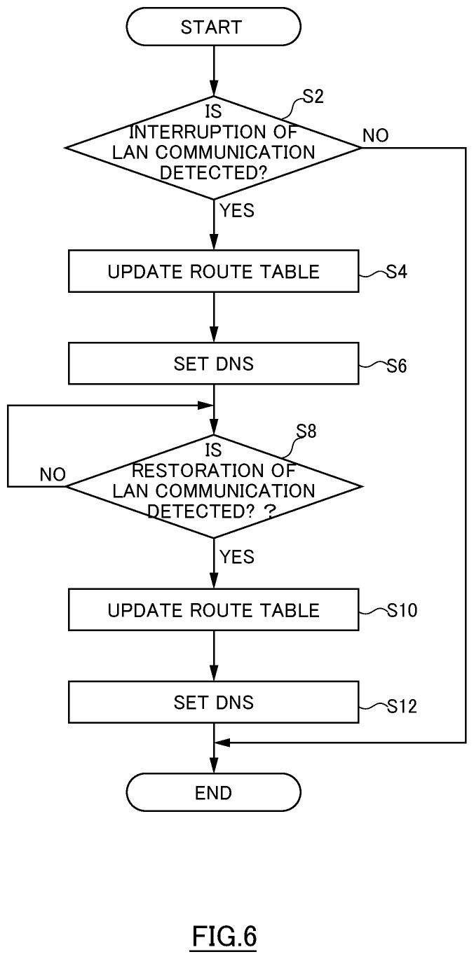

The memory of the control unit 31 stores a route table. The control unit 31 executes processing (described below with reference to FIG. 6) when communication malfunction occurs in the communication in the LAN. When communication malfunction occurs in the communication with the user terminal 2 during the communication with the user terminal 2 via the gateway GW1, the control unit 31 switches a gateway set as the default gateway from the gateway GW1 to the gateway GW2 and thereby controls the communication unit 37 so as to communicate with the management server 5.

When the communication with the user terminal 2 is interrupted, the control unit 31 controls the communication unit 37 so as to switch an DNS server to access for resolving a domain name, from the DNS server 71 connected to the LAN, to the DNS server 81 connected to the mobile communication network MCN.

As described below, in one embodiment, the above-described LAN analyzer (one example of a LAN analysis unit) is incorporated in the control unit 31, as a part of firmware functions. The LAN analyzer analyzes a packet received by the communication unit 37 via the LAN. A cause of interruption of the communication via the LAN can be analyzed based on an analysis file acquired by the LAN analyzer.

A start and a stop of the packet analysis made by the LAN analyzer are controlled by commands received from the management server 5 via the communication unit 37 through the mobile communication network and the like.

The operation input unit 32 includes, for example, an input device such as a button, or a touch input device incorporated in a display panel of the display unit 23. The operation input unit 32 receives an operation input made by the user. The display unit 33 includes a display panel such as an LCD and a display drive circuit, for example. The display unit 33 displays results of execution of the firmware.

The feed unit 34 includes a platen roller, a motor drive circuit, and a stepping motor which are not illustrated in the drawings. The feed unit 34 is configured to feed a print media such as a label in the printer 3.

The printing unit 35 includes a thermal head and a head drive circuit which are not illustrated in the drawings. The printing unit 35 is configured to perform printing by causing electric current to selectively flow through a plurality of heating elements of the thermal head, in response to a print request.

The storage 36 is a non-volatile memory. For example, the storage 36 is a solid state drive (SSD) such as a flash memory. For example, the storage 36 stores the analysis file acquired by the LAN analyzer. The storage 36 also stores the route table.

The communication unit 37 communicates, via the gateway GW1 connected to the LAN, with an external device that is connected to the LAN and whose examples include the user terminal 2. In other words, the communication unit 37 receives or transmits packets via the LAN by being controlled by the control unit 31.

The communication unit 37 communicates with the management server 5 or the administrator terminal 6 via the Internet IN through the gateway GW2 that is connected to the mobile communication network MCN. For example, the communication unit 37 includes a communication circuit, an antenna, a slot, and the like. The communication circuit is provided for making connection to the mobile communication network MCN via the SIM card and the like. The SIM card can be inserted into the slot.

In one embodiment, the communication unit 37 is controlled by the control unit 31 to transmit the state information of the printer 3 and the setting information of the printer 3 to the management server 5, for example, periodically. A timing of transmitting the state information is not particularly limited, and may be, for example, a predetermined timing that arrives at an interval (e.g., at an interval of 15 minutes) between 10 minutes and 30 minutes. A timing of transmitting the setting information is not particularly limited, and may be, for example, a timing when an event of a setting change in the printer 3 occurs.

A communication protocol used in the communication between the communication unit 37 and the management server 5 is not particularly limited, and may be the MQTT or the MQTT over WebSocket, for example.

The management server 5 includes a control unit 51, a storage 52, and a communication unit 53 as illustrated in FIG. 2.

The control unit 51 is constituted mainly by a microprocessor and a memory, and controls the entire management server 5. For example, the microprocessor included in the control unit 51 executes a management program, and thereby acquires the state information and the setting information for each of a plurality of the management-target printers 3, from the corresponding printer 3, to appropriately update an unillustrated printer management database. The printer management database is a database for storing the state information and the setting information for each of a plurality of the printers 3.

The control unit 51 functions as an analysis request unit and an acquisition unit. The analysis request unit requests the printer 3 to cause the LAN analyzer to analyze a packet. The acquisition unit acquires, from the printer 3, a result (analysis file) of the analysis made by the LAN analyzer.

In one embodiment, the control unit 51 stores, in the storage 52, the analysis file acquired from the printer 3.

The storage 52 is, for example, a large-scale storage device such as a hard disk drive (HDD). The storage 52 stores the printer management database and the analysis file. The communication unit 53 is a communication interface for communicating with the printer 3 and the administrator terminal 6.

The administrator terminal 6 unitarily manages the state information and the setting information of a plurality of the printers 3. The administrator terminal 6 includes a control unit 61, an operation input unit 62, a display unit 63, and a communication unit 64 as illustrated in FIG. 2.

The control unit 61 is constituted mainly by a microprocessor and a memory, and controls the entire administrator terminal 6. For example, the microprocessor included in the control unit 61 executes the printer management application.

The administrator or the like makes predetermined operation on the printer management application, and thereby, the printer management application causes the display unit 63 to display the state information and the setting information for the specific printer 3 or to display the analysis file acquired by the specific printer 3. Thereby, the administrator or the like can easily identify a cause of a malfunction in the printer 3 at which the malfunction has occurred, and thus, can support the user of the printer 3.

The operation input unit 62 includes an input device. For example, the input device is one or both of a mouse and a keyboard, or is a touch input device incorporated in a display panel of the display unit 63. The operation input unit 62 receives an operation input made by the user. The display unit 63 includes a display panel such as an LCD and a display drive circuit, for example. The display unit 63 displays a result of execution of the printer management application.

The communication unit 64 is a communication interface for communicating with the printer 3 and the management server 5. A communication protocol used in the communication between the communication unit 64 and the management server 5 is not particularly limited, and may be HTTPS, for example.

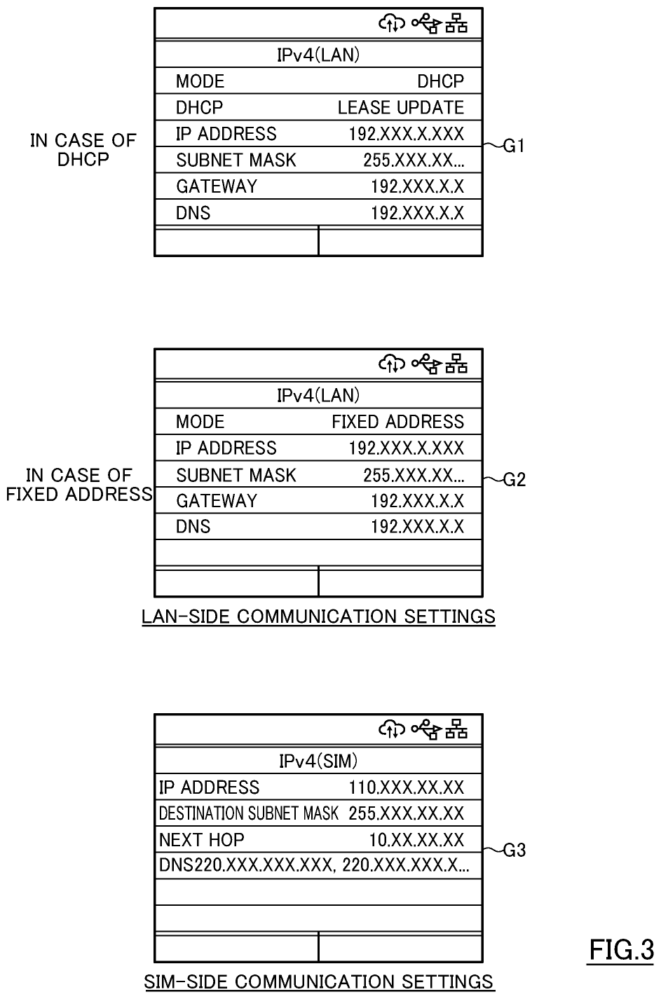

As described above, in one embodiment, the display unit 33 of the printer 3 includes a touch panel screen. The user of the printer 3 can check communication settings of the printer 3 by operating a button on the screen. FIG. 3 illustrates image display examples in the printer 3 in one embodiment, for LAN-side communication settings and for SIM-side communication settings.

In a case of using the LAN, the user of the printer 3 can select either the DHCP or a fixed address. An image G1 in FIG. 3 represents the image example for the LAN-side communication settings when the DHCP is selected. An image G2 in FIG. 3 represents the image example for the LAN-side communication settings when the fixed address is selected. An image G3 in FIG. 3 represents the image example for the SIM-side communication settings.

In the LAN-side communication settings in FIG. 3, the item of “gateway” indicates an IP address (i.e., the IP address of the gateway GW1) of the default gateway, and the item of “DNS” indicates an IP address of the DNS server. In the SIM-side communication settings in FIG. 3, the item of “next hop” indicates an IP address (i.e., the IP address of the gateway GW2) of a packet transfer destination.

As illustrated in FIG. 2, a static route is fixed to “0.0.0.0” in the SIM-side communication settings, and cannot be changed by the user. For this reason, the static route is not included in the items in the image G3.

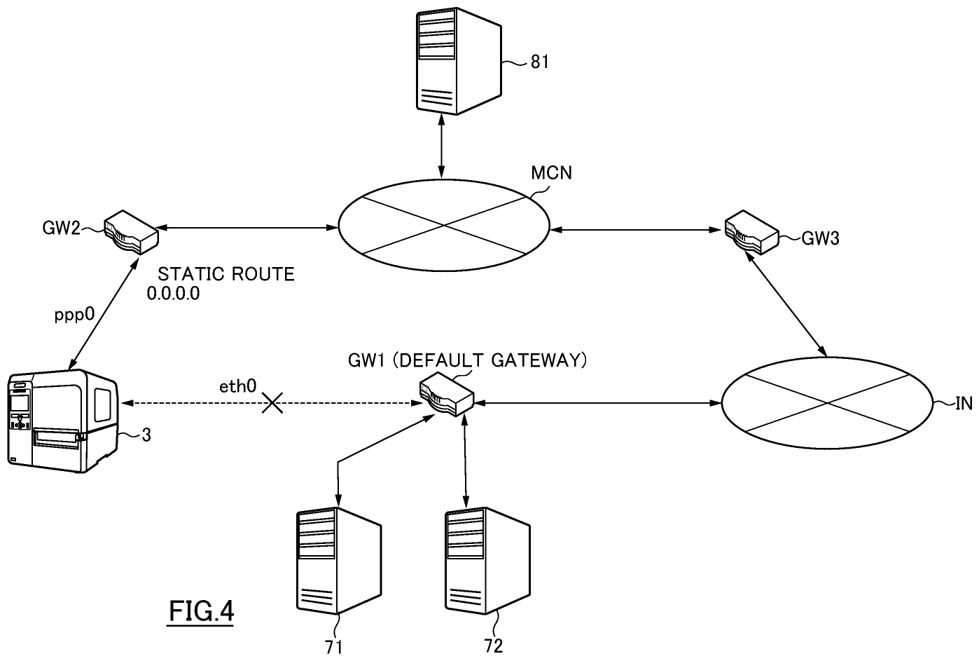

Next, it is assumed that communication malfunction occurs in communication of the communication unit 37 of the printer 3 with the user terminal 2 while the communication unit 37 is communicating with the user terminal 2 via the gateway GW1. Supposed examples of a cause of the communication malfunction in the communication with the user terminal 2 include detachment of a LAN cable from the printer 3 and a malfunction of the gateway GW1. In contrast to FIG. 2, FIG. 4 illustrates a state where communication between the printer 3 and the gateway GW1 is interrupted.

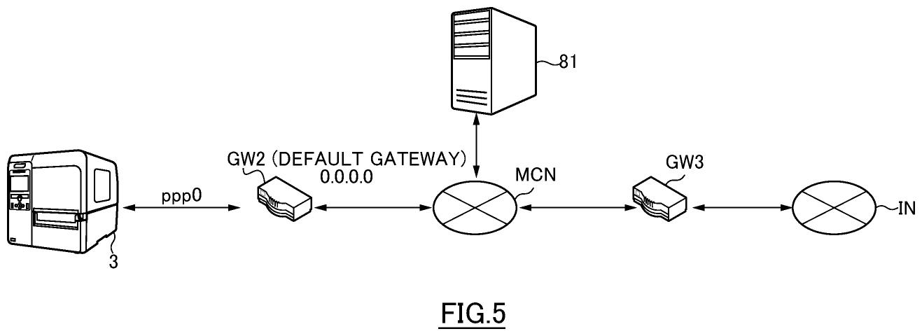

When the communication malfunction occurs in the communication with the user terminal 2 during the communication with the user terminal 2 via the gateway GW1, the control unit 31 of the printer 3 controls the communication unit 37 by changing a gateway set as the default gateway from the gateway GW1 to the gateway GW2 in order to secure communication with the Internet IN. FIG. 5 illustrates the communication path from the printer 3 to the Internet IN when a gateway set as the default gateway is changed to the gateway GW2.

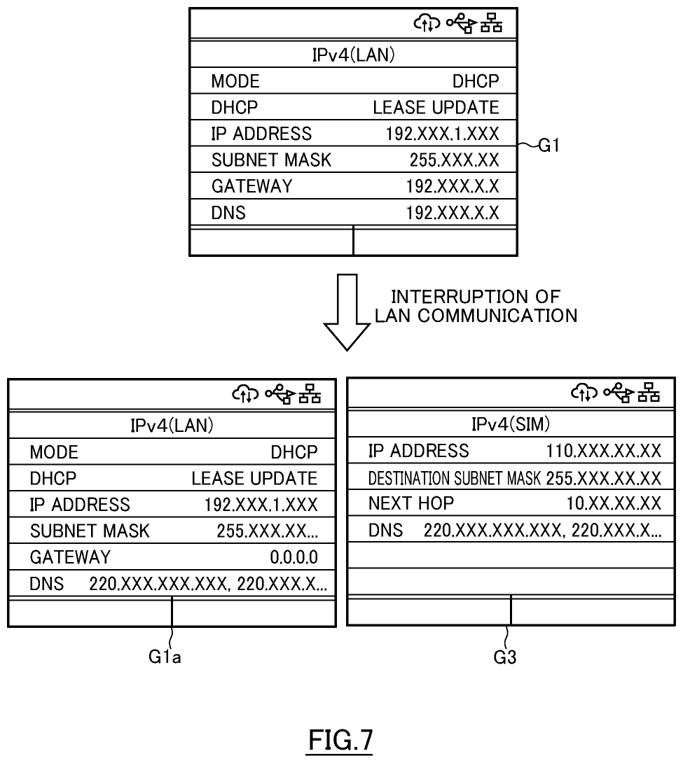

With reference to FIG. 6 and FIG. 7, the following describes processing of the control unit 31 of the printer 3 when LAN communication is interrupted due to a communication malfunction of the LAN during the communication of the communication unit 37 of the printer 3 with the user terminal 2 via the gateway GW1 in a case where the communication unit 37 is connected to the management server 5 via the SIM.

FIG. 6 is a flowchart representing the processing in the printer 3 when the LAN communication is interrupted. FIG. 7 illustrates an example of a display change of an image for communication settings in the printer 3 when the LAN communication of the printer 3 is interrupted. The image G1 in FIG. 7 before the LAN communication is interrupted is the same as the image G1 in FIG. 3. The image G3 in FIG. 7 for SIM-side communication settings after the LAN communication is interrupted is the same as the image G3 in FIG. 3.

When the control unit 31 of the printer 3 detects interruption of the LAN communication (step S2: yes), the control unit 31 updates the route table in the storage 36 (step S4). The default gateway is written in the route table, as a gateway to which packets are first transferred.

After the LAN communication is interrupted, the LAN-side communication settings are changed to those of an image G1a, as illustrated in FIG. 7. As represented in the image G1a, the setting of the default gateway is changed to “0.0.0.0”, and the DNS server 71 on the LAN-side cannot be used. Thus, at the step S4, the printer 3 updates the route table in the storage 36 so as to switch a gateway set as the default gateway from the gateway GW1 to the gateway GW2. Even after the LAN communication is interrupted, when the session is not terminated, the communication with the management server 5 can be continued via the static route on a side of the SIM. However, the HTTPS communication session is temporary, and the session is terminated due to a radio wave condition in some case. In this case, the DNS server 71 on the LAN-side cannot resolve the domain name.

In view of the above, the control unit 31 of the printer 3 switches the default gateway from the gateway GW1 to the gateway GW2. Further, the printer 3 updates the setting of the DNS server so as to use the DNS server 81 on the mobile communication network MCN-side instead of the DNS server 71 on the LAN-side (step S6). Thereby, the printer 3 is enabled to communicate with the management server 5 and the administrator terminal 6 connected to the external Internet IN when the communication with the user terminal 2 via the LAN is interrupted.

When the control unit 31 of the printer 3 detects restoration of the LAN communication (step S8: yes), the control unit 31 updates the route table in the storage 36 so as to switch a gateway set as the default gateway from the gateway GW2 to the gateway GW1 (step S10). Further, the control unit 31 of the printer 3 updates the setting of the DNS server so as to use the DNS server 71 on the LAN-side instead of the DNS server 81 on the mobile communication network MCN-side (step S12). In other words, when the communication with the user terminal 2 via the LAN is restored, the setting of the default gateway is automatically returned to the original setting without requiring operation by the user, thereby enabling the communication via the gateway GW1 with the management server 5 and the administrator terminal 6 that are connected to the external Internet IN.

The processing of the flowchart in FIG. 6 is limited to the case where the LAN-side communication setting is the DHCP. In a case where the LAN-side communication setting is a fixed address, when the LAN communication is interrupted, the DNS server cannot be accessed in the SIM-side communication after the session is terminated. Thus, the domain name becomes unable to be resolved. For this reason, the control unit 31 of the printer 3 then terminates connection that uses the MQTT or the MQTT over WebSocket for example and that is made with the management server 5. In this case, after the LAN communication is restored, the control unit 31 attempts reconnection that uses the MQTT or the MQTT over WebSocket and that is made with the management server 5.

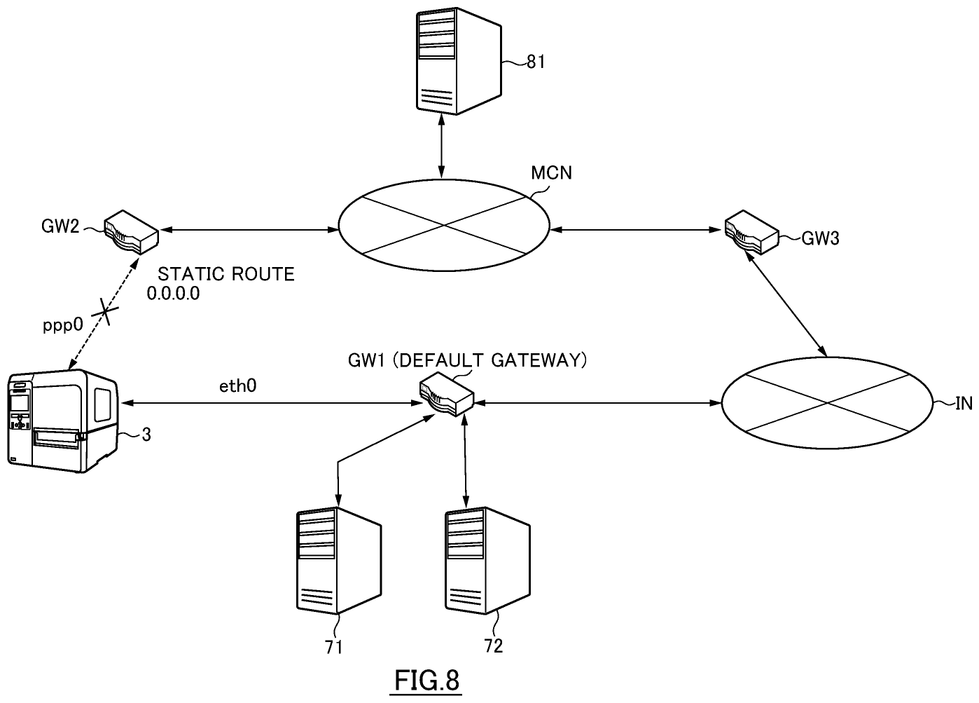

Next, it is assumed that communication malfunction occurs in communication of the communication unit 37 of the printer 3 with the management server 5 while the communication unit 37 is communicating with the management server 5 via the gateway GW2. Supposed examples of a cause of the communication malfunction in the communication with the management server 5 include detachment of the SIM card from the printer 3. In contrast to FIG. 2, FIG. 8 illustrates a state where communication between the printer 3 and the gateway GW2 is interrupted.

When the communication with the management server 5 is interrupted during the communication via the gateway GW2 with the management server 5 for example, the control unit 31 of the printer 3 changes a gateway set as the default gateway from the gateway GW2 to the gateway GW1 in order to secure communication with the Internet IN.

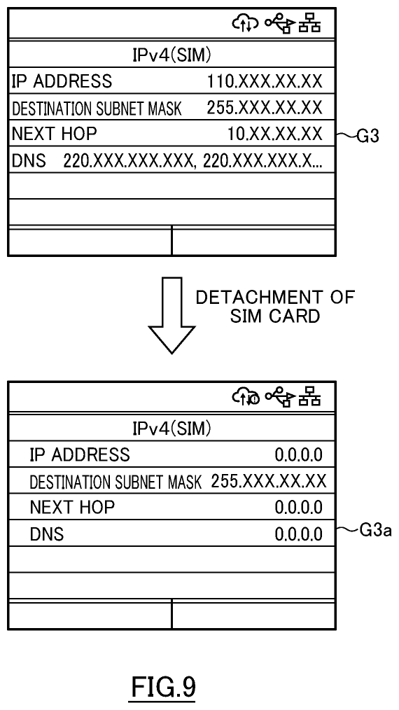

FIG. 9 illustrates an example of a display change of an image for SIM-side communication settings in the printer 3 when the communication by the printer 3 via the SIM is interrupted. The image G3 in FIG. 9 before the communication via the SIM is interrupted is the same as the image G3 in FIG. 3. After the communication via the SIM is interrupted, the SIM-side communication settings are changed to those of an image G3a. As represented in the image G3a, the settings of a next hop and a DNS are each cleared to be “0.0.0.0”. When the SIM card is reinserted and the communication via the SIM thus becomes enabled, the SIM-side communication settings are returned from those of the image G3a to those of the image G3.

When the SIM card is reinserted, settings of a SIM-side IP address, a next hop (gateway GW2), and a DNS server are assigned again by the DHCP server 72.

As described above, the printer 3 according to the present embodiment includes the communication unit 37 that communicates with the user terminal 2 via the gateway GW1 connected to the LAN and that communicates with the management server 5 via the gateway GW2 connected to the mobile communication network MCN. When the communication with the user terminal 2 is interrupted during the communication with the user terminal 2 via the gateway GW1, the control unit 31 of the printer 3 controls the communication unit 37 by switching a gateway set as the default gateway from the gateway GW1 to the gateway GW2. Thus, when the communication with the user terminal 2 via the LAN is interrupted, the printer 3 can communicate with the management server 5 connected to the external network.

Next, one embodiment of processing of the printer 3 when the LAN communication is interrupted due to occurrence of communication malfunction in the LAN communication will be described.

The processing of the printer 3 when the LAN communication is interrupted due to the communication malfunction in the LAN communication is described above with reference to FIG. 6. This processing secures the communication path with the management server 5 and the administrator terminal 6 by the communication via the SIM. Thus, a cause of the interruption of the LAN communication can be identified via this communication path.

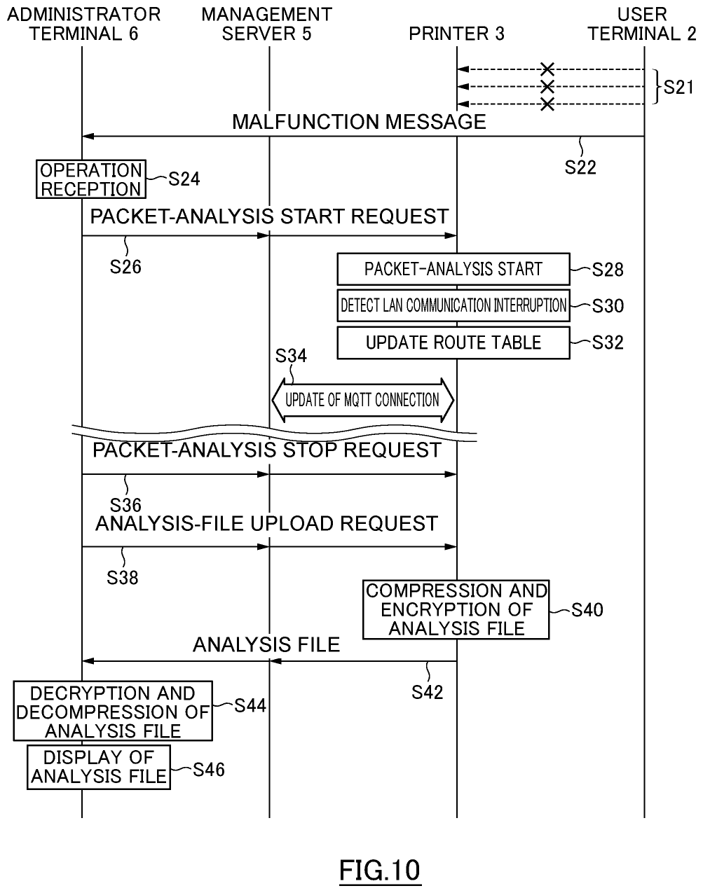

With reference to a sequence chart illustrated in FIG. 10, the following describes the processing of the printer 3 in one embodiment when the LAN communication is interrupted. In FIG. 10, it is assumed that the printer 3 periodically communicates with (e.g., transmits the state information and the setting information to) the management server 5 via the gateway GW1 by the MQTT before the LAN communication is interrupted.

As illustrated in FIG. 10, for example, when the user terminal 2 attempts to cause the printer 3 to issue a printed label, but cannot communicate with the printer 3, the user terminal 2 displays a message or the like indicating that the communication cannot be established (step S21). The user terminal 2 transmits, to the administrator terminal 6 for example, a message indicating that a malfunction has occurred (step S22). The message at the step S22 may be transmitted by the printer management application when the application is installed in the user terminal 2, or may be transmitted by email or the like, for example. Instead of the step S22, the user may notify the administrator of the malfunction occurrence by telephone.

The control unit 61 of the administrator terminal 6 receives predetermined operation from the operation input unit 62, on an image displayed by the printer management application (step S24). The administrator makes this predetermined operation for remotely operating the LAN analyzer of the printer 3 in order to analyze a LAN-communication state of the printer 3.

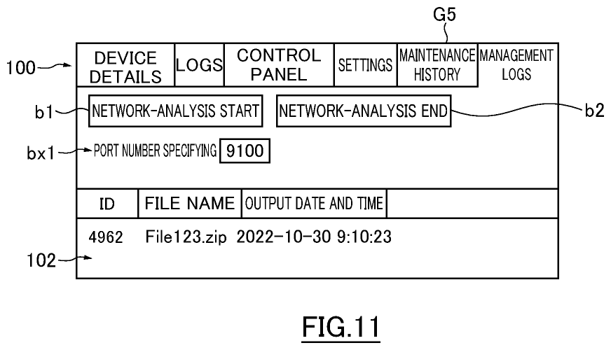

FIG. 11 illustrates an image G5 that is an example of the image displayed by the printer management application of the administrator terminal 6. The image G5 includes a tab group 100 including a plurality of tabs, buttons b1 and b2, a text box bx1, and an analysis file list 102. Operating the button bl causes reception of the remote operation to the LAN analyzer of the printer 3. In the remote operation to the LAN analyzer, an analysis-target port number can be specified by inputting the port number in the text box bx1.

In response to the operation received at the step S24, the control unit 61 of the administrator terminal 6 transmits, for example, a packet-analysis start request to the management server 5 via the communication unit 64 by the printer management application. In response to the packet-analysis start request, the control unit 51 of the management server 5 transmits an MQTT message to the printer 3 via the communication unit 53 (step S26). The LAN analyzer of the printer 3 interprets the received MQTT message for example, and starts to analyze packets received from the LAN (step S28). In other words, the LAN analyzer analyzes the packets in response to the request acquired from the management server 5 via the mobile communication network MCN.

It is assumed that the LAN analyzer has already been activated at the time of receiving the MQTT message at the step S26. When the LAN analyzer is not activated, packets cannot be analyzed. However, in this case, activating the LAN analyzer after restoration of the communication with the LAN enables packets to be analyzed when the communication with the LAN is interrupted again. When the communication with the LAN is frequently interrupted, the LAN analyzer may be activated in advance.

Here, when the control unit 31 of the printer 3 detects interruption of the LAN communication (step S30), the control unit 31 updates the route table to change a gateway set as the default gateway from the gateway GW1 to the gateway GW2 (step S32). Further, the control unit 31 of the printer 3 updates the MQTT connection with the management server 5 (step S34). In updating the MQTT connection, the control unit 31 updates a set DNS server from the DNS server 71 on the LAN-side to the DNS server 81 on the mobile communication network MCN-side. Processing at each of the steps S30 to S34 is the same as the corresponding processing at the steps S2 to S6, respectively, represented in FIG. 6.

When a time length required to analyze a LAN-communication state of the printer 3 has elapsed, the control unit 61 of the administrator terminal 6 transmits a packet-analysis stop request to the management server 5 in response to the administrator operating the button b2 (refer to FIG. 11) on the image that is displayed on the administrator terminal 6 by the printer management application. The control unit 51 of the management server 5 transmits an MQTT message to the printer 3 in response to the packet-analysis stop request by connecting to the mobile communication network MCN via the communication unit 53 by a SIM for example (step S36). The control unit 31 of the printer 3 interprets the MQTT message received at the step S36, and thus controls the LAN analyzer so as to stop analyzing packets received from the LAN.

Next, the control unit 61 of the administrator terminal 6 transmits an analysis-file upload request via the communication unit 64 to the printer 3 by way of the management server 5. The LAN analyzer of the printer 3 compresses and encrypts an analysis file representing the analysis result of the packets (step S40), and transmits the compressed and encrypted analysis file to the management server 5 (step S42). Even when a failure occurs in the communication via the LAN, the printer 3 can transmit the analysis file to the management server 5 by connecting to the mobile communication network MCN via the gateway GW2. The management server 5 stores the received analysis file in association with identification information of the printer 3 that is a transmission source of the file.

The control unit 61 of the administrator terminal 6 receives predetermined operation, on the printer management application. The administrator makes this predetermined operation for specifying the analysis file. Upon receiving this operation, the control unit 61 requests the analysis file from the management server 5, thus acquires the analysis file, and displays the acquired analysis file on the display unit 63. The acquired analysis file is displayed in the analysis file list 102 on the image G5 in FIG. 11. The printer management application activates a network analyzer in response to predetermined operation specifying the analysis file in the analysis file list 102, decrypts and decompresses the analysis file (step S44), and displays the analysis file in a format that facilitates analysis to be made by the administrator (step S46).

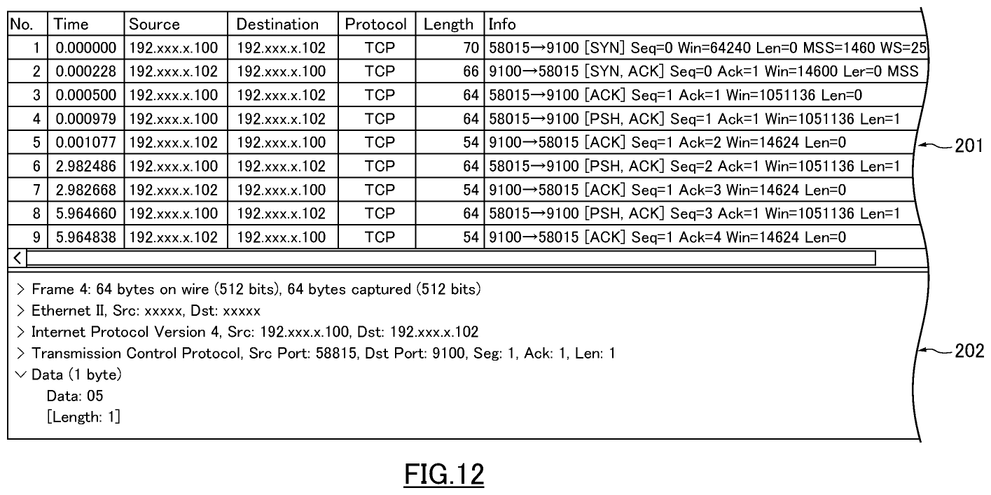

FIG. 12 illustrates one example of the analysis file displayed at the step S46.

The image example illustrated in FIG. 12 includes an outline display section 201 and a detail display section 202. The outline display section 201 is a section that represents an outline of one or more captured packets and that includes rows each associated with one packet. The rows each includes data of packet capture time (time), a transmission source IP address (source), a destination IP address (destination), a protocol (protocol), a data length (length), and outline information (info). By referring to the image illustrated in FIG. 12, the administrator or the like for example can analyze and resolve a cause of a communication error in a case of occurrence of the communication error such as one in which the printer 3 cannot communicate with the user terminal 2 via the LAN.

At this time, the control unit 51 of the management server 5 may automatically determine presence or absence of a communication malfunction caused by the LAN, based on the analysis file acquired from the printer 3. Then, for example, the control unit 51 may request the printer 3 to change a setting of the communication protocol, based on the determination result. For example, when the control unit 51 of the management server 5 identifies an error state or the like that is associated in advance with the setting information and the state information to be acquired from the printer 3, the control unit 51 requests the LAN analyzer of the printer 3 to make analysis related to the identified error state. The management server 5 may refer to a determination table that is associated in advance with a status command or the like and the printer setting information and the state information. Thereby, the management server 5 may identify a communication error that is caused by the LAN and that is associated with the status command extracted from the analyzed packet and with the setting information and the state information acquired from the printer. In this case, the management server 5 may request the printer 3 to change a setting of the communication protocol, depending on the identified communication error.

In one embodiment, when the LAN communication is interrupted, the control unit 31 of the printer 3 may control the communication unit 37 by restricting a communication port allowed in communicating with the management server 5 via the gateway GW2, in order to enhance security of the communication.

In the case of the communication via the gateway GW2, prohibiting use of a communication port unrelated to the communication with the management server 5 or the administrator terminal 6 enables the printer 3 to be protected from a threat of access from an outside. In one embodiment, the communication ports of the port numbers 8883 (MQTT), 443 (HTTPS or MQTT over WebSocket), and 53 (DNS) exist as the communication port allowed in communicating via the gateway GW2.

Although one embodiment of the printer, the program, and the information processing system according to the present invention is described above in detail, the present invention is not limited to the above-described embodiment. The above-described embodiment can be variously improved or modified within a range that does not depart from the essence of the present invention.

The present invention is related to Japanese Patent Application No. 2022-185417 filed with the Japan Patent Office on Nov. 21, 2022, the entire contents of which are incorporated into the description of the present application by reference.

1. A printer comprising:
a communication unit comprising a communication circuit and an antenna, wherein the communication unit is configured to communicate with a first device via a first gateway and to communicate with a second device via a second gateway, the first gateway being connected to a local area network (LAN) and set as a default gateway, the second gateway being connected to a mobile communication network; and
a control unit comprising a microprocessor and a memory, wherein the control unit is programmed such that, when communication malfunction occurs in communication with the first device during the communication with the first device via the first gateway, switches a gateway set as the default gateway from the first gateway to the second gateway and thereby controls the communication unit so as to communicate with the second device.

2. The printer according to claim 1, wherein
the control unit is programmed such that, when the communication with the first device is restored, the control unit controls the communication unit by switching a gateway set as the default gateway from the second gateway to the first gateway.

3. The printer according to claim 1, comprising
a LAN analysis unit programmed to analyze a packet received via the LAN.

4. The printer according to claim 3, wherein
the LAN analysis unit is programmed to analyze the packet in response to a request transmitted from the second device and received via the mobile communication network.

5. The printer according to claim 1, wherein
when the communication with the first device is interrupted, the control unit controls the communication unit by restricting a communication port allowed in communicating with the second device via the second gateway.

6. The printer according to claim 1, wherein
the control unit is programmed such that, when the communication with the first device is interrupted, the control unit controls the communication unit so as to switch a domain name system (DNS) server to access for resolving a domain name, from a first DNS server connected to the LAN to a second DNS server connected to the mobile communication network.

7. A non-transitory storage medium storing a program that, when installed in a printer:
causes a communication unit, which comprises a communication circuit and an antenna, to communicate with a first device via a first gateway and to communicate with a second device via a second gateway, the first gateway being connected to a local area network (LAN) and set as a default gateway, the second gateway being connected to a mobile communication network; and
causes a control unit comprising a microprocessor and a memory to, when communication malfunction occurs in communication with the first device during the communication with the first device via the first gateway, switch a gateway set as the default gateway from the first gateway to the second gateway and thereby control the communication unit to communicate with the second device.

8. An information processing system comprising a printer, and a server communicable with the printer,
the printer comprising:
a communication unit comprising a communication circuit and an antenna, wherein the communication unit is configured to communicate with an information processing device via a first gateway and communicates with the server via a second gateway, the first gateway being connected to a local area network (LAN) and set as a default gateway, the second gateway being connected to a mobile communication network;
a control unit comprising a microprocessor and a memory, wherein the control unit is programmed such that, when communication malfunction occurs in communication with the information processing device during the communication with the information processing device via the first gateway, switches a gateway set as the default gateway from the first gateway to the second gateway and thereby controls the communication unit so as to communicate with the server; and
a LAN analysis unit programmed to analyze a packet received via the LAN,
the server comprising:
an analysis request unit programmed to request the printer to analyze a packet by the LAN analysis unit; and
an acquisition unit programmed to acquire, from the printer, a result of analysis made by the LAN analysis unit.

9. The printer according to claim 2, comprising
a LAN analysis unit programmed to analyze a packet received via the LAN.

10. The printer according to claim 2, wherein
the control unit is programmed such that, when the communication with the first device is interrupted, the control unit controls the communication unit by restricting a communication port allowed in communicating with the second device via the second gateway.

11. The printer according to claim 2, wherein
the control unit is programmed such that, when the communication with the first device is interrupted, the control unit controls the communication unit so as to switch a domain name system (DNS) server to access for resolving a domain name, from a first DNS server connected to the LAN to a second DNS server connected to the mobile communication network.
